(19) United States
(12) Patent Application Publication
(10) Pub. No.: US 2023/0324203 A1
(43) Pub. Date: Oct. 12, 2023

(54) MEASURING DEVICE AND ASSOCIATED OPERATING METHOD

(71) Applicant: Testo SE & Co. KGaA, Titisee-Neustadt (DE)

(72) Inventor: Sebastian BACH, Breitnau (DE)

(73) Assignee: Testo SE & Co. KGaA, Titisee-Neustadt (DE)

(21) Appl. No.: 18/130,644

(22) Filed: Apr. 4, 2023

(30) Foreign Application Priority Data
Apr. 8, 2022 (DE) 102022108540.6

(51) Int. Cl. G01D 9/00; H02J 7/34

(52) U.S. Cl. CPC G01D 9/005; H02J 7/345

(57) ABSTRACT

In order to prolong maintenance-free and autonomous operation of an electrical measuring device (1) having an internal energy store (4) and measuring electronics (3) for reading a sensor (2), wherein the latter is configured for detecting an ambient variable such as, for instance, a room temperature or room humidity, it is provided that as needed, in a manner dependent on an ambient temperature detected by the measuring device (1), a buffer capacitor (5) is electrically connected to the energy store (4) such that the buffer capacitor (5) can draw electrical power from the energy store (4) and can make this power available again, in particular in the event of a dip in an electrical operating voltage of the measuring device (1), in order thus to buffer current peaks of a load current of the measuring electronics (3).

### CROSS-REFERENCE TO RELATED APPLICATIONS

This application claims priority to German Patent Application No. 10 2022 108 540.6, filed Apr. 8, 2022, which is incorporated herein by reference as if fully set forth.

### TECHNICAL FIELD

The invention relates to a measuring device comprising a sensor for detecting an ambient variable such as, for instance, a room temperature or a room humidity. Furthermore, the measuring device has measuring electronics configured for reading the sensor and for acquiring measurement values of the sensor. Said measuring electronics is supplied with electrical operating voltage by an electrical energy store of the measuring device.

### BACKGROUND

Such measuring devices are previously known and are often used as so-called data loggers, often in the form of a radio logger, in order in particular wirelessly to capture and thus to document measurement values, for instance of the temperature or of the room humidity, at a specific location over relatively long periods of time.

Typical requirements in such applications are service lives of several years, where the measuring device has to be operated in a manner free of faults and free of maintenance without a change of battery during such a period of time. An added difficulty here is that the temperature range to which the data logger is subjected can have fluctuations for example between −25° C. and +85° C. This is challenging precisely with regard to a long battery lifetime since batteries react in very different ways to great changes in temperature and there is the risk of failure of the battery.

### SUMMARY

Proceeding from this background, the invention is based on the object of improving the possibilities for use of measuring devices as described in the introduction. In particular, the objective set for the invention is to increase the time period in which such a measuring device can be operated reliably and in a manner free of maintenance autonomously with respect to other energy sources.

In order to achieve this object, a measuring device with one or more of the features disclosed herein is provided. In particular, therefore, according to the invention, in order to achieve said object, in the case of a measuring device of the type mentioned in the introduction, it is proposed that a buffer capacitor is provided, which is chargeable by means of the energy store and which can supply an electric current to the measuring electronics in addition to the energy store. Moreover, provision is made for the buffer capacitor to be designed so as to be able to be connected and disconnected.

In other words, the invention thus proposes providing the electrical operating voltage, as necessary, not only by way of the energy store but also with the aid of the buffer capacitor then connected up. If the aforementioned measuring electronics draws a large load current (current peak), for example, then without the use of the buffer capacitor the operating voltage would possibly dip, which can occur in particular at low temperatures if the energy store can make available only specific maximum currents.

The technical solution described thus has the advantage that the buffer capacitor can buffer current peaks in relation to a load current drawn by the measuring electronics during operation of the measuring device, in the sense of supplying an additional current. That is to say that if such a current peak occurs, it does not have to be handled completely by the energy store, rather the current is then provided at least partly by the buffer capacitor.

An electrical switch, for example in the form of a relay or a transistor circuit, can be provided for connecting and disconnecting the buffer capacitor.

According to the invention, the object can also be achieved by means of further advantageous embodiments as descried below and in the claims.

In this regard, according to the invention, provision can be made for connecting the buffer capacitor to be configured in a manner dependent on a detected ambient temperature.

By way of example, the measuring device, in particular the aforementioned measuring electronics, can be configured to detect an ambient temperature continuously, that is to say in particular at regular intervals, with the aid of a temperature sensor and to electrically connect the buffer capacitor as soon as the detected ambient temperature falls below a limit temperature. In the case of such a design, it is preferred if the measuring device/measuring electronics is furthermore configured to electrically disconnect the buffer capacitor if the detected ambient temperature exceeds the limit temperature again.

Electrical disconnection can be understood here to mean in particular that the buffer capacitor is thereby decoupled from the measuring electronics and the energy store in such a way that it can no longer draw current from the energy store and can no longer supply current to the measuring electronics. By contrast, if the buffer capacitor is connected, it can perform both of these functions.

What is advantageous about this solution is that, in a manner dependent on an instantaneous ambient temperature detected by the temperature sensor, the measuring device independently either can use the buffer capacitor in order to sustain peaks of the load current of the measuring electronics and/or, in particular at higher temperatures above the aforementioned limit temperature, can electrically decouple the buffer capacitor from the electrical circuit of the measuring device in order thus to avoid undesired shunt currents in the capacitor.

In this case, the invention has recognized that the use of the buffer capacitor is generally expedient only at low temperatures, that is to say when the electrical energy store is able to supply less current in a temperature-dictated manner. At high temperatures, by contrast, the energy store offers enough current intensity and so the use of the buffer capacitor can be dispensed with, as a result of which in particular leakage currents can be avoided.

The aforementioned sensor of the measuring device that is operated with the aid of the energy store can be the temperature sensor, in particular; however, it can also be some other sensor, for example a moisture sensor.

One possible design of the invention provides for a comparison logic to be embodied, which causes the buffer capacitor to be connected in the event of a first temperature threshold value being undershot and causes the buffer capacitor to be electrically isolated in the event of a second temperature threshold value being exceeded. In the case of such a design, it is preferred if for this purpose the comparison logic drives an electrical switch that electrically connects the buffer capacitor to the energy store and/or the measuring electronics.

In this case, the second temperature threshold value can be identical to the first temperature threshold value or else be a few degrees Celsius above the first temperature threshold value.

The electrical energy store can be designed for example as a non-rechargeable electrochemical energy store. Furthermore, it is likewise possible to design the energy store as a rechargeable electrical battery.

One design provides for the buffer capacitor, in relation to the measuring electronics, to be electrically connected in parallel with the electrical energy store. In this case, the buffer capacitor can share a common electrical ground with the energy store.

A measuring device according to the invention can be embodied or configured in particular for the automatically recurring capture of measurement values with the aid of the sensor according to a defined and/or adjustable time schedule. As a result, measurement data can be recorded in an ordered manner over relatively long periods of time.

In this case, the measuring device can acquire measurement values and record these measurement values continuously using the sensor with the aid of the electrical energy store autonomously with respect to other energy sources. As a result, the measuring device can be used as a data logger.

Provision can thus be made for the measuring device to be designed as a portable handheld measuring device and/or as an energy-autonomous measuring device, in particular in the form of a data logger.

In order to achieve the object mentioned in the introduction, a method according to the invention is furthermore proposed, which enables temperature-optimized operation of a measuring device to be achieved. In this case, the measuring device has features as described in the introduction.

In order to achieve the object, in the case of the method, it is provided that the measuring device independently and continuously detects an ambient temperature and electrically connects and disconnects a buffer capacitor in a manner dependent on the detected ambient temperature in such a way that the buffer capacitor can draw electrical power from the internal electrical energy store as needed, in particular at low ambient temperatures below 0° C., and can make it available (in the event of a high current demand) to the measuring electronics for the operation thereof.

The method can furthermore be developed by virtue of the fact that the measuring device disconnects the buffer capacitor if a specific limit temperature is exceeded. In this case, no electric current flow whatsoever from the energy store into the buffer capacitor can take place any longer. This in particular prevents the energy store from being loaded by undesired leakage or shunt currents in the buffer capacitor, which would unnecessarily limit the service life/lifetime of the measuring device.

### BRIEF DESCRIPTION OF THE DRAWINGS

The invention will now be described in greater detail on the basis of an exemplary embodiment, but is not restricted to this example. Rather, further embodiments of the invention can be gathered from the following description in conjunction with the general description, the claims and the drawings.

Here:

FIG. 1: shows a schematic, greatly simplified, illustration of a measuring device according to the invention.

### DETAILED DESCRIPTION

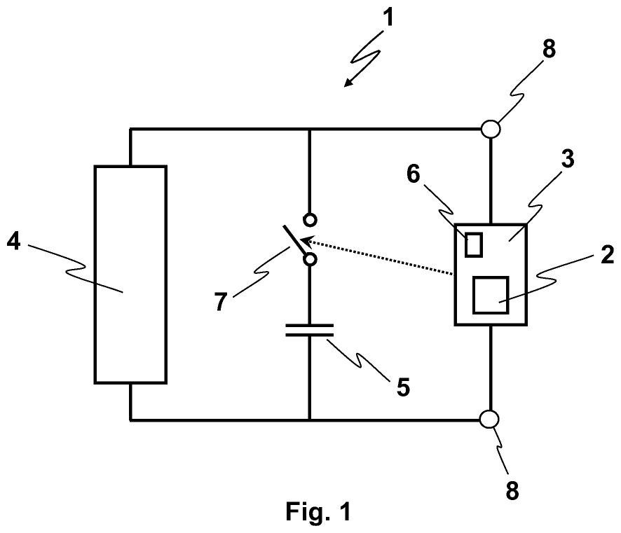

The sole FIG. 1 shows a schematic diagram of the electrical components of a measuring device 1 according to the invention. The measuring device 1 comprises a sensor 2 for detecting an ambient variable such as, for instance, the room humidity and an associated measuring electronics 3, for example including a controller, configured for reading the sensor 2 and for acquiring measurement values of the sensor 2.

The measuring device 1 in FIG. 1 is designed as a data logger and for this purpose is configured, automatically at recurring time intervals, to capture measurement values with the aid of a sensor 2 and to store these measurement values in an internal memory. Due to the electrical operating voltage that can be made available by the electrical energy store 4, the measuring device 1 can thus be operated autonomously with respect to other energy sources in order thus to continuously acquire and record measurement values using the sensor 2.

As is illustrated on the basis of the electrical connections in FIG. 1, an electrical operating voltage is fed to the measuring electronics 3 by an electrical energy store 4. A switching arrangement comprising a buffer capacitor 5 and an electrical switching means 7 connected in series therewith is connected in parallel with the two connection terminals 8 of the measuring electronics 3, via which the latter is electrically connected to the energy store 4. The electrical switching means 7 is illustrated as an electrical switch in FIG. 1 and can be realized for example with a semiconductor component or a relay.

Since the switching arrangement comprising buffer capacitor 5 and switching means 7 is also electrically connected to the energy store 4, the buffer capacitor 5 can be charged by means of the energy store 4 when the switching means 7 is correspondingly switched, i.e. the switch 7 is closed. In this switching state, that is to say when both poles of the buffer capacitor 5 are electrically connected to the two terminals of the measuring electronics 3, the buffer capacitor 5 can supply an electric (discharge) current to the measuring electronics 3 in addition to the energy store 4 and can thus stabilize the operating voltage dropped across the two terminals 8 of the measuring electronics 3.

In other words, the buffer capacitor 5 (provided that it was electrically charged from the energy store 4 to a sufficient extent beforehand) can discharge into the two terminals 8 of the measuring electronics 3 as soon as the switching means 7 electrically connects the buffer capacitor 5. If necessary, however, by way of the opening of the switch 7, that is to say by way of renewed switching of the switching means 7, it is also possible if necessary for the buffer capacitor 5 to be disconnected, i.e. electrically isolated from the measuring electronics 3. By means of such electrical disconnection of the buffer capacitor 5, the latter can thus be electrically decoupled from the measuring electronics 3 and the energy store 4, with the result that although on the one hand the buffer capacitor 5 can no longer supply current to the measuring electronics 3, on the other hand it can also no longer draw current from the energy store 4. Such a procedure can be advantageous in order to avoid an energy consumption on account of shunt currents in the capacitor (leakage currents), since such shunt currents can unnecessarily load the energy store 4, in particular if the additional current flow supplied by the capacitor 5 is not required at present, for instance because there is no occurrence of relatively large current peaks in the current consumption of the measuring electronics 3.

In order that connecting and disconnecting the buffer capacitor 5 can proceed intelligently and automatically, the measuring electronics 3 continuously measures the ambient temperature with the aid of an additional temperature sensor 6. If the ambient temperature thus detected falls below a predefined limit temperature, then the measuring electronics 3 connects the buffer capacitor 5 by virtue of the fact that, for this purpose, said measuring electronics drives the switching means 7 in a suitable manner, as is illustrated by the dotted arrow in FIG. 1. That is to say that at low temperatures at which current peaks may typically occur, the buffer capacitor 5 is available for buffering these current peaks (which occur in the consumption by the measuring electronics 3).

As soon as the ambient temperature detected by the measuring electronics 3 with the aid of the temperature sensor 6 rises above the aforementioned limit temperature again, the measuring electronics 3 disconnects the buffer capacitor 5 by way of corresponding renewed driving of the switching means 7 and thus interrupts the electrical connection between the buffer capacitor 5 and the measuring electronics 3. In this case, the limit temperature is chosen such that in the temperature range above the limit temperature, the measuring electronics 3 is able to be supplied with electric current by the energy store 4 to a sufficient extent. As a result of the disconnection of the buffer capacitor 5 at warmer temperatures, the entire current consumption of the measuring device 1, which after all can be drawn exclusively from the energy store 4 (since the capacitor 5 can only buffer-store electrical energy from the energy store 4), is thus reduced, thus giving rise to a longer lifetime or operational period of the measuring device 1.

It is easily conceivable with reference to FIG. 1 that, provided that for example the lower connecting terminal 8 of the measuring electronics 3 is grounded, the buffer capacitor 5 shares a common electrical ground with the energy store 4.

The measuring device 1 shown in FIG. 1 thus also implements a method according to the invention for the temperature-optimized operation of the measuring device 1. This is because the measuring device 1 independently and continuously detects the ambient temperature with the aid of the separate temperature sensor 6 and, in a manner dependent on this detected ambient temperature, as was explained above, electrically connects and disconnects the buffer capacitor 5 by way of the driving of the corresponding switching means 7. As a result, as needed, namely as soon as the detected ambient temperature falls below the aforementioned threshold value, the buffer capacitor 5 is electrically connected to the terminals 8 of the measuring electronics 3 and in this case can firstly draw electrical power from the internal electrical energy store 4 (charging process of the capacitor 5) in order subsequently—as necessary—to feed the electrical energy buffer-stored in this way in the form of a discharge current (discharging process of the capacitor 5) into the switching arrangement shown in FIG. 1 and thus to make it available to the measuring electronics 3 for the operation thereof.

In summary, in order to prolong maintenance-free and autonomous operation of an electrical measuring device 1 having an internal energy store 4 and measuring electronics 3 for reading a sensor 2, wherein the latter is configured for detecting an ambient variable such as, for instance, a room temperature or room humidity, it is proposed that as needed, in a manner dependent on an ambient temperature detected by the measuring device 1, a buffer capacitor 5 is electrically connected to the energy store 4 with the aid of a suitable switching means 7 in such a way that the buffer capacitor 5 can draw electrical power from the energy store 4 and can make this power available again, in particular in the event of a dip in an electrical operating voltage of the measuring device 1, in order thus to buffer current peaks of a load current of the measuring electronics 3 (cf. FIG. 1).

### LIST OF REFERENCE SIGNS

1 Measuring device
2 Sensor
3 Measuring electronics
4 Energy store
5 Buffer capacitor
6 Temperature sensor
7 Switching means
8 Connecting terminal (of 3)

1. A measuring device (1), comprising:
a sensor (2) for detecting an ambient variable;
measuring electronics (3) configured for reading the sensor (2) and for acquiring measurement values of the sensor (2), said measuring electronics being supplied with electrical operating voltage by an electrical energy store (4); and
a buffer capacitor (5) that
is chargeable by the energy store (4) and
is arranged to supply an electric current to the measuring electronics (3) in addition to the energy store (4), and
is configured to be connected and disconnected.

2. The measuring device (1) as claimed in claim 1, wherein the ambient variable is a room temperature or room humidity.

3. The measuring device (1) as claimed in claim 1, wherein the connecting of the buffer capacitor (5) is dependent upon a detected ambient temperature.

4. The measuring device (1) as claimed in claim 1, wherein the sensor is a temperature sensor (6), and the measuring device (1) is configured to detect an ambient temperature continuously or at regular intervals with the temperature sensor (6) and to electrically connect the buffer capacitor (5) as soon as the detected ambient temperature falls below a limit temperature, and to electrically disconnect the buffer capacitor (5) if the detected ambient temperature exceeds the limit temperature again.

5. The measuring device (1) as claimed in claim 1, wherein the measurement electronics is configured with a comparison logic which causes the buffer capacitor (5) to be connected in the event of a first temperature threshold value being undershot and causes the buffer capacitor (5) to be electrically isolated in the event of a second temperature threshold value being exceeded.

6. The measuring device (1) as claimed in claim 5, further comprising
an electrical switch that is driven by the comparison logic in the measurement electronics that electrically connects the buffer capacitor (5) to at least one of the energy store (4) or the measuring electronics (3).

7. The measuring device (1) as claimed in claim 1, wherein the electrical energy store (4) comprises a non-rechargeable electrochemical energy store or a rechargeable electrical battery.

8. The measuring device (1) as claimed in claim 1, wherein the buffer capacitor (5), in relation to the measuring electronics (3), is electrically connected in parallel with the electrical energy store (4).

9. The measuring device (1) as claimed claim 1, wherein the measuring device (1) is configured for automatic recurring capture of measurement values using the sensor (2) according to a time schedule.

10. The measuring device (1) as claimed in claim 1, wherein the measuring device (1) is configured acquire and record measurement values continuously using the sensor (2) and the electrical energy store (4) autonomously with respect to other energy sources.

11. The measuring device (1) as claimed in claim 1, wherein the measuring device (1) is at least one of a portable handheld measuring device or an energy-autonomous measuring device (1).

12. A method for temperature-optimized operation of a measuring device (1), the method comprising:
providing the measuring device (1) which includes a sensor (2) for detecting an ambient variable, measuring electronics (3) configured for reading the sensor (2) and for acquiring measurement values of the sensor (2), said measuring electronics being supplied with electrical operating voltage by an electrical energy store (4), and a buffer capacitor (5);
independently and continuously detecting an ambient temperature using the measuring device (1); and
the measuring device electrically connecting the buffer capacitor (5) dependent on the detected ambient temperature dropping below a limit temperature such that the buffer capacitor (5) draws electrical power from the internal electrical energy store (4) as needed, and the buffer capacitor (5) supplying electrical power as necessary to the measuring electronics (3) for operation thereof.

13. The method of claim 12, wherein the limit temperature is ambient temperatures below 0° C.

14. The method as claimed claim 12, further comprising
the measuring device (1) disconnecting the buffer capacitor (5) if a further limit temperature is exceeded such that no electric current flow whatsoever from the energy store (4) into the buffer capacitor (5) is possible.
